(19) United States
(12) Patent Application Publication
(10) Pub. No.: US 2026/0359158 A1
(43) Pub. Date: Nov. 12, 2026

(54) SYSTEM, METHOD AND APPARATUS FOR FILTERING CONFIGURATION ACCESSES TO UNIMPLEMENTED DEVICES

(71) Applicant: Intel Corporation, Santa Clara, CA (US)

(72) Inventors: Tao Xu, Shanghai (CN); Changpeng Guo, KunShan (CN)

(73) Assignee: Intel Corporation, Santa Clara, CA (US)

(21) Appl. No.: 19/121,550

(22) PCT Filed: Dec. 1, 2022
(86) PCT No.: PCT/CN2022/135770

§ 371 Date: Apr. 16, 2025

(51) Int. Cl. G06F 11/07; G06F 13/10

(52) U.S. Cl. CPC G06F 11/0781; G06F 11/0745; G06F 11/0772; G06F 13/102

(57) ABSTRACT

In one embodiment, an apparatus includes a filter to receive a first configuration read access request and direct the first configuration read access request to a first root port, and receive a second configuration read access request and prevent the second configuration read access request from being sent to a second root port, where a destination of the first configuration read access request is an implemented device of a system and a destination of the second configuration read access request is an unimplemented device of the system. The apparatus also includes a storage to store an identification of implemented devices and unimplemented devices. Other embodiments are described and claimed.

### BACKGROUND

Many computing systems couple components together using industry standard interconnects such as Peripheral Component Interconnect Express (PCIE) or Compute Express Limited (CXL) interconnects. In such systems, bus enumeration is a frequent operation performed by system software, e.g., while an operating system (OS) is initializing a PCIE/CXL hierarchy or installing/uninstalling a device driver. System software scan the PCIE/CXL bus to determine what devices are actually present. To do this, the system software read a Vendor ID in each possible PCIE/CXL ID. A Host Bridge returns a value of all 1's on read accesses to configuration space registers of non-existent devices, meaning that no function is present if a vendor ID is 0xFFFF for a specific PCIE/CXL ID.

However, read access to configuration space registers of non-existent devices terminate with an Unsupported Request Error. This error is propagated and is eventually escalated into a system error, which triggers an interrupt. In the case of many non-present devices, a large number of errors are incurred, leading to an interrupt burst, which causes system performance degradation in case of correctable errors or crash in case of uncorrectable errors. One solution is to disable this error reporting, but this can adversely affect proper system operation.

### BRIEF DESCRIPTION OF THE DRAWINGS

FIG. 1 is a block diagram of at least a portion of a system in accordance with an embodiment.

FIG. 2 is a flow diagram of a method in accordance with an embodiment.

FIG. 3 is a flow diagram of a method in accordance with another embodiment.

FIG. 4 is a block diagram of an existing device map in accordance with an embodiment.

FIG. 5 is an embodiment of a fabric composed of point-to-point links that interconnect a set of components.

FIG. 6 is a block diagram of a system in accordance with an embodiment.

FIG. 7 is a block diagram of a system in accordance with another embodiment.

FIG. 8 is a block diagram of another example system in accordance with an embodiment.

### DETAILED DESCRIPTION

In various embodiments, a system is configured to prevent configuration register read accesses to non-existent devices, by filtering such reads from reaching their targets. In this way, unsupported request errors resulting from the non-existent devices do not occur. With this arrangement, a system may maintain enabled system-wide unsupported request error reporting enabled, and not be overwhelmed by errors that would otherwise be reported as a result of reads to non-existent devices.

In one or more embodiments, filter circuitry may be implemented within a fabric to identify incoming configuration read requests and to prevent such read requests to absent devices from being sent along. In addition, this filter circuitry may provide an appropriate response in the case of these filtered read requests. With embodiments, unsupported request errors can be avoided during PCIE/CXL bus scanning. By avoiding these errors, there is no performance degradation during PCIE/CXL bus scanning due to unsupported request errors. At the same time, unsupported request error reporting can remain enabled, both during system initialization and normal system operation, to increase system availability.

In an embodiment, this filter circuity may be implemented within a root complex. This filter circuitry is referred to herein as a fabric filter, which can be used in combination with a storage that maintains an existing device map. In a particular embodiment, this storage may be one or more registers implemented within the root complex and coupled to the fabric filter.

With this arrangement, while a system is booting, firmware such as basic input output system (BIOS) scans a PCIE fabric behind the root complex. This scan occurs before system error reporting is enabled, such that any unsupported request error generated at this time does not cause any side effect. After the scanning is done, the BIOS then creates the existing device map (e.g., as stored in one or more registers such as a capabilities register block of the root complex), and enables the fabric filter. In an embodiment, each device (more specifically each bus, device and function (BDF)) in the fabric may be allocated a dedicated bit or other indicator in the existing device map, to indicate whether it is present (and thus accessible) or not.

Once the fabric filter is enabled, the filter receives configuration read requests and, if it determines that a read request is directed towards a non-existent device, it prevents the request from being further processed or sent, and instead returns to the requester a successful completion with a data value of 0xFFFF.

In this way, Unsupported Request Error Reporting can be enabled throughout the system, and Unsupported Request Errors can be avoided completely while PCIE/CXL bus scanning. In a particular system, unsupported request error reporting can be enabled, e.g., by appropriate control of device control registers. In a PCIe example, a device control register may have an unsupported error reporting enable bit set, and a mask bit reset (DevCtl.URRE=1 and Uncerrmsk.UREM=0).

With the filter circuitry herein, even when performing a bus scan to non-existent devise (or bus or function), there is no unsupported request error generated (UncerrstsURES=0).

By allowing a system to keep an Unsupported Request Error Reporting enabled during normal operation, various errors can be identified. For example, this error reporting mechanism can be used to report errors including: unaligned or wrong-size access to a register block; unsupported size of request to a Memory Space; Memory/IO Space access before Memory/IO decode is enabled; device programming model violation; invalidated request due to flit corruption, among others. In this way, these normal errors can be resolved to either stop the violation or recover from it, and further enable a system to predict such failures. In contrast, without embodiments and when such error reporting is disabled, systems can become silently corrupted, adversely impacting system availability.

In various embodiments, a root complex may be configured to identify when an incoming configuration read access is directed to a non-existent device and prevent the read from occurring. Furthermore, the root complex may be configured to send a predetermined response value to a requester of the read access to indicate the non-presence (e.g., a value of FFFFh as discussed above).

In this way, appropriate identification of present and absent devices (also referred to herein as “implemented” and “unimplemented” devices) may occur, while at the same time preventing unsupported request errors from being reported, logged. As further used herein, the terms “implemented device” and “unimplemented device” also refer to implemented/unimplemented buses or functions. Thus more generally the terms “implemented device” and “unimplemented device” refer to any of bus, device or function. As a result, error handling techniques, including interrupt generation and handling can be avoided, maintaining normal system operation.

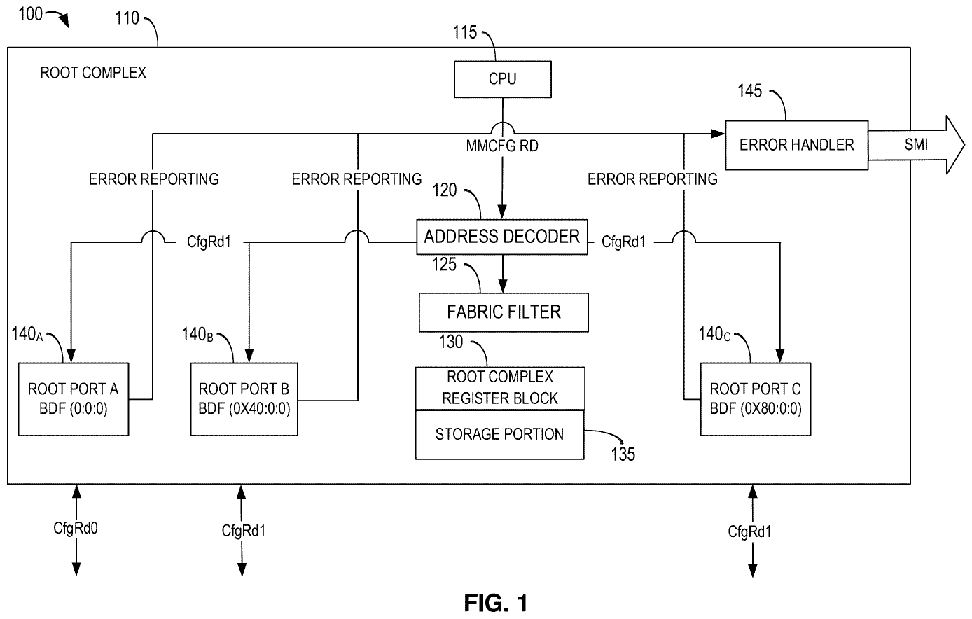

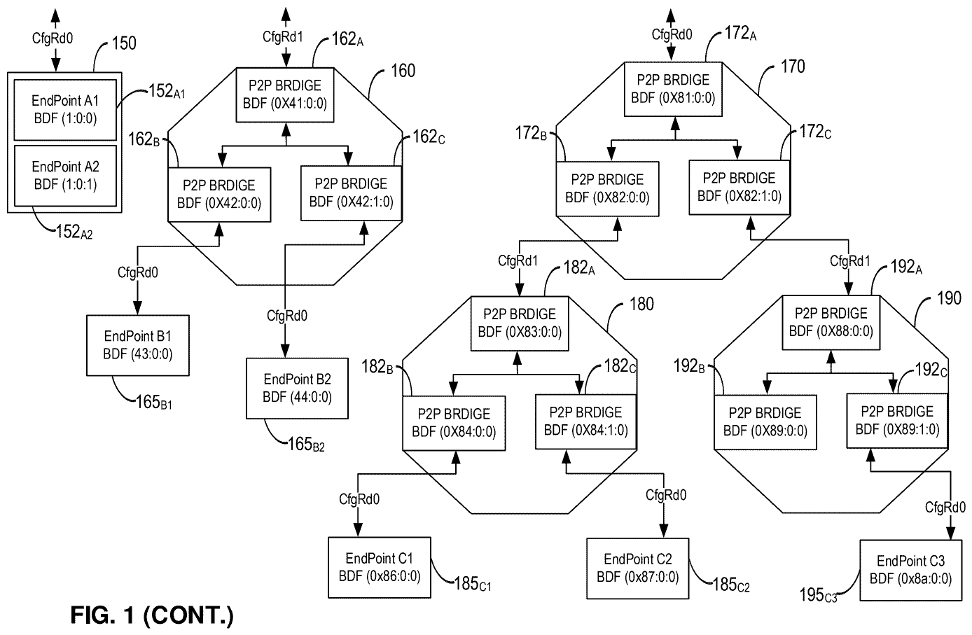

Referring now to FIG. 1, shown is a block diagram of at least a portion of a system in accordance with an embodiment. As shown in FIG. 1, system 100 may be any type of computing device, ranging from a relatively small device such as a smartphone, tablet computer, laptop computer, and so forth, to larger devices such as desktop computers or other client devices and/or server systems. In the high level shown in FIG. 1, system 100 is implemented as a PCIE-based system. However, embodiments are not so limited that it may be applicable to other communication fabric such as a CXL-based fabric, as an example.

As illustrated in FIG. 1, system 100 includes a root complex 110. In one or more embodiments, root complex 110 may be implemented as a semiconductor package including one or more individual dies. In the high level shown in FIG. 1, root complex 110 includes a central processing unit (CPU) 115 which may be implemented on one or more dies and may include a plurality of cores and/or other processing circuits. As further illustrated, CPU 115 couples to an address decoder 120. Address decoder 120 may be configured to receive access requests from CPU 115 and decode corresponding addresses to identify appropriate destinations. In a particular embodiment, when address decoder 120 receives a configuration read request as a memory mapped input/output (MMIO) request, which it converts a configuration read transaction layer packet (TLP), and directed to a corresponding root port to which a given device is mapped.

With regard to configuration read requests, address decoder 120 may, in turn, communicate a decoded address and the corresponding configuration read request to a fabric filter 125. In embodiments herein, fabric filter 125 may be implemented as hardware circuitry, e.g., register transfer logic (RTL), or other control circuitry to receive such configuration requests and filter or otherwise prevent any such requests directed to unimplemented devices from being forwarded, thus preventing unsupported request errors from being generated.

To identify whether a given device is present or not, filter 125 is coupled to a register block 130. In one or more embodiments, register block 130 may include a root complex capabilities register block in accordance with a given PCIe specification. With embodiments, register block 130 may further include a storage portion 135 that is configured to store an existing device map. As will be described herein, storage portion 135 may store a map encoding (with a particular encoding for BDF) to identify present and non-present devices.

Still referring to FIG. 1, filter 125, based on look ups to register block 130, may thus filter out configuration read requests to unimplemented devices and instead forward such configuration read requests for implemented devices. More particularly as shown, for a present device, a configuration read request may be directed to a corresponding one of a plurality of root ports 140a-c.

As further shown, when unsupported request or other errors are identified, they are provided to an error handler 145. In one or more embodiments, error handler 145 may be configured to signal errors, e.g., by raising a system management interrupt (SMI) or other interrupt.

Still with reference to FIG. 1, each root port couples to a given device. Specifically, root port 140_{A} couples to a device 150 including endpoints 152_{A1, A2}. In turn, root port 140B couples to a switch 160 that includes a plurality of point-to-point (P2P) bridges 162_{A-C}. As shown, endpoints 165_{B1, B2} couple to switch 160. Further, root port 140_{C} couples to a hierarchy of switches 170, 180, and 199, each including P2P bridges (172_{A-C}, 182_{A-C}, 192_{A-C}), and coupled endpoints 185_{C1, C2}, and 195_{C3}. Although shown at this high level in the embodiment of FIG. 1, many variations and alternatives are possible.

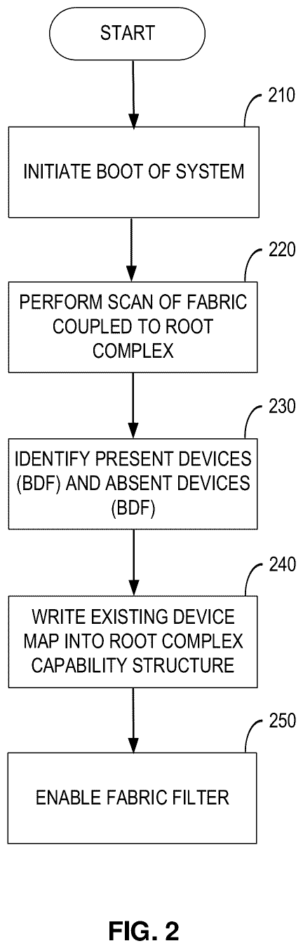

Referring now to FIG. 2, shown is a flow diagram of a method in accordance with an embodiment. More specifically as shown in FIG. 2, method 200 is a method for identifying present and non-present devices in accordance with an embodiment, which may be performed during system boot, e.g., by basic input/output system (BIOS) or other firmware. As such, method 200 may be performed by hardware circuitry such as a CPU that executes BIOS or other firmware. In other cases, method 200 may be performed by BIOS or other system software executing on the CPU. As illustrated, method 200 begins by initiating a boot of a system (block 210), which may occur on a system power up or other reset. During boot, at block 220, a scan of a fabric coupled to a root complex is performed. For example, BIOS may perform a PCIe fabric scan. During this scan, a CPU may send configuration read requests to read values such as vendor IDs at each possible ID location (e.g., BDF locations). As discussed above, responsive to these configuration read requests, present devices may send back its vendor ID, while for non-present devices a corresponding host bridge may send a completion with an unsupported request (UR) flag. In turn, root complex circuitry may synthesize a completion message having a predetermined value (e.g., 0xFFFF). Note that such operation may also trigger logging of unsupported request errors. However, in this pre-boot environment such errors may be ignored.

Still with reference to FIG. 2, next at block 230, based on these responses, present and absent devices (as enumerated by BDF) are identified. Based at least in part on this information, at block 240, an existing device map is written into the root complex (e.g., by BIOS). More specifically, this existing device map may be written in an encoded manner into registers of a capabilities register space of the root complex. Finally, at block 250, a fabric filter may be enabled. As described above, this fabric filter may be used to prevent configuration reads to absent devices from being sent, thus avoiding unsupported request errors and corresponding error reporting. Understand while shown at this high level in the embodiment of FIG. 2, many variations and alternatives are possible.

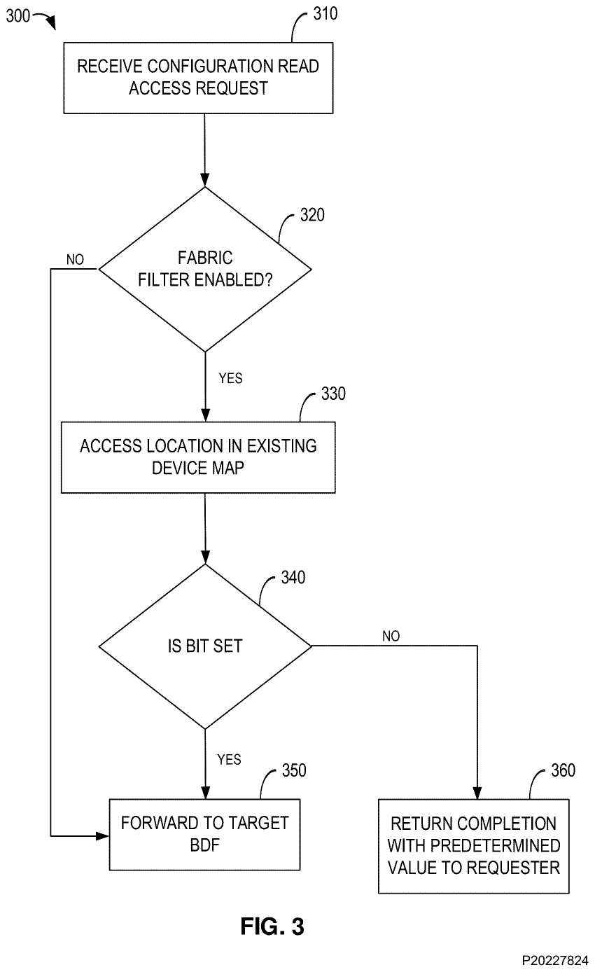

Referring now to FIG. 3, shown is a flow diagram of a method in accordance with another embodiment. More specifically, method 300 of FIG. 3 is a filter method to prevent configuration read accesses from being directed to absent devices. In an embodiment, method 300 may be performed by hardware circuitry such as a fabric filter as may be implemented in a given root complex.

As shown, method 300 begins by receiving a configuration read access request (block 310). This configuration read request may be a MMIO configuration read request received from a CPU. At diamond 320, it is determined whether the fabric filter is enabled. This is so, since in typical implementations, this filter is disabled by default after system reset, and then BIOS or other firmware enables it after bus scanning and the existing device map is created. If the filter is not enabled, control passes to block 350 where the configuration read request may be forwarded to its intended target, according to an address decoding function (as may be performed by an address decoder coupled to the fabric filter). Understand that a given device (if present) can respond to this configuration read request by sending a vendor ID and/or other information such as contents of any register in the device's configuration space. In the case of an unimplemented device, a bridge component may send a value of 0xFFFF (and additional circuitry may log and raise an unsupported request error).

Still referring to FIG. 3, instead if it is determined that the fabric filter is enabled, control passes to block 330. At block 330, the fabric filter may access a location in an existing device map to determine whether the given device is present. In an embodiment, a set bit within a corresponding location within the existing device map indicates presence of the device and a zero value indicates its absence.

Depending upon the returned value, the determination at diamond 340 as to whether this bit is set or not is made and control passes to a given one of blocks 350 and 360. Thus if the device is present, the configuration read request is forwarded to the device while instead, if the device is absent control passes to block 360 where the fabric filter may send a predetermined value, e.g., 0xFFFF to the requester.

Although shown at this high level in the embodiment of FIG. 3, many variations and alternatives are possible.

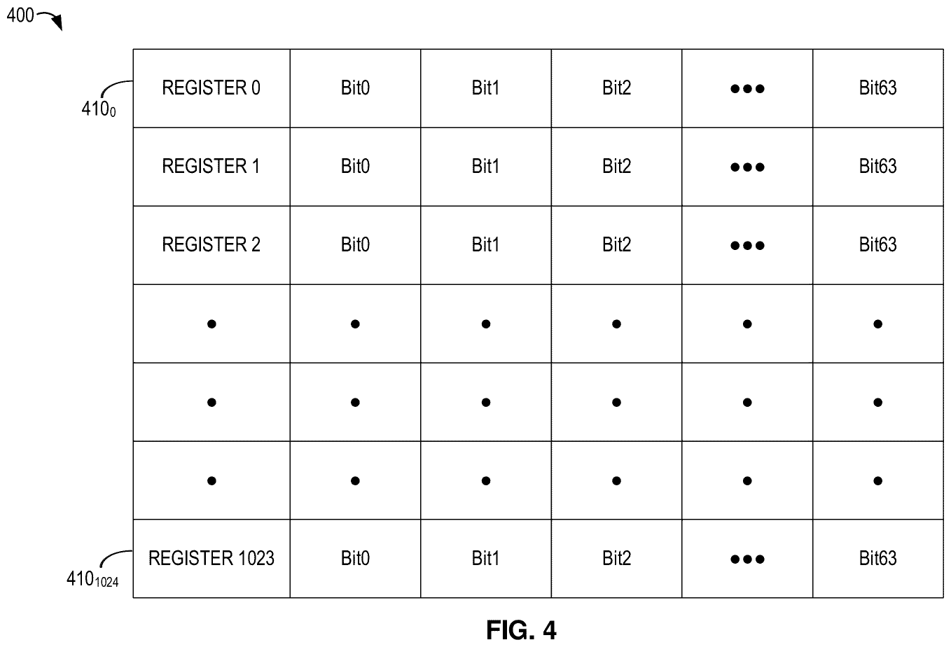

Referring now to FIG. 4, shown is a block diagram of an existing device map in accordance with an embodiment. As shown in FIG. 4, device map 400 may be implemented within a plurality of registers 4100-4101023. In the embodiment shown, each register provides 64 bits of storage locations. In one or more embodiments, map 400 may be an encoded map in which each bit corresponds to a given BDF identifier. When set, the bit indicates presence of the BDF and when reset, indicates its absence.

In an embodiment, the bit position for a given BDF may be determined in accordance with the following equation:

Bit Position=x*32*8+y*8+z,

where x equals bus number, y equals device number and z equals function number. As such, each register equals bit position/64 and a given bit in a register equals bit position MOD 64. Of course, other encodings are possible in other embodiments.

In a hot plug capable root port without a device connected while system is booting, BIOS can enforce to disable Unsupported Request Error reporting ((URRE) e.g., by setting a device control register to disable this feature and set the existing device map to presume that all devices behind the root port are existing. Later during OS operation, while a hot plug event is happening, BIOS can correct the existing device map and re-enable URRE by hooking an ACPI method for hot plug.

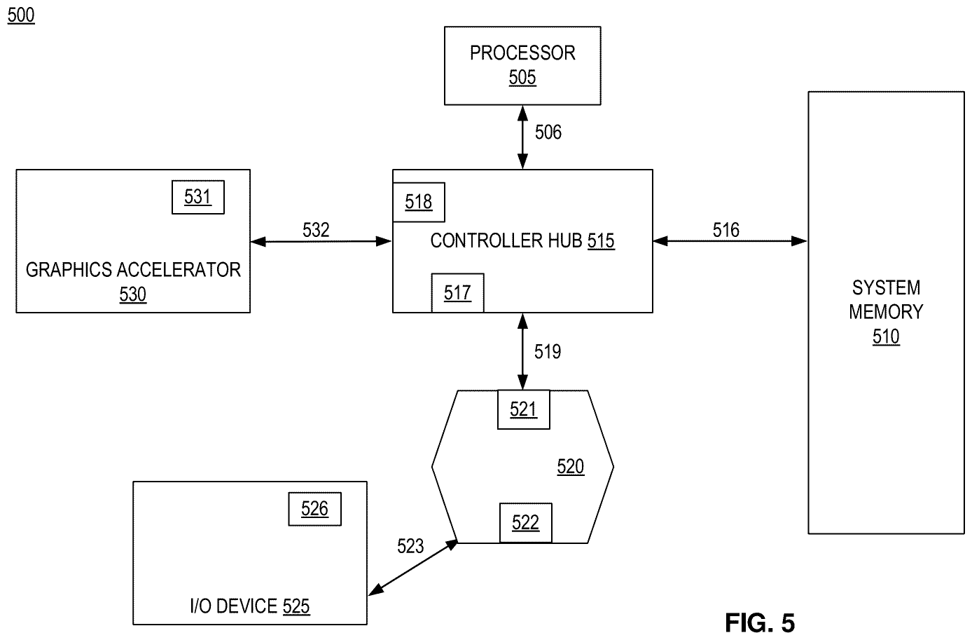

Embodiments may be implemented in a wide variety of systems. Referring to FIG. 5, an embodiment of a fabric composed of point-to-point links that interconnect a set of components is illustrated. System 500 includes processor 505 and system memory 510 coupled to controller hub 515. Processor 505 includes any processing element, such as a microprocessor, a host processor, an embedded processor, a co-processor, or other processor. Processor 505 is coupled to controller hub 515 through a link 506, such as an Intel® UPI serial point-to-point interconnect.

System memory 510 includes any memory device, such as random access memory (RAM), non-volatile (NV) memory, or other memory accessible by devices in system 500. System memory 510 is coupled to controller hub 515 through memory interface 516. Examples of a memory interface include a double-data rate (DDR) memory interface, a dual-channel DDR memory interface, and a dynamic RAM (DRAM) memory interface.

In one embodiment, controller hub 515 is a root hub, root complex, or root controller in a PCIe interconnection hierarchy. Controller hub 555 may include filter circuitry and storage for an existing device map as described herein.

Examples of controller hub 515 include a chipset, a memory controller hub (MCH), a northbridge, an interconnect controller hub (ICH), a southbridge, and a root controller/hub. Often the term chipset refers to two physically separate controller hubs, i.e. a memory controller hub (MCH) coupled to an interconnect controller hub (ICH). Note that current systems often include the MCH integrated with processor 505, while controller 515 is to communicate with I/O devices, in a similar manner as described below. In some embodiments, peer-to-peer routing is optionally supported through root complex 515.

Here, controller hub 515 is coupled to switch/bridge 520 through serial link 519. Input/output modules 517 and 521, which may also be referred to as interfaces/ports 517 and 521, include/implement a layered protocol stack to provide communication between controller hub 515 and switch 520. In one embodiment, multiple devices are capable of being coupled to switch 520. Switch/bridge 520 couples to a device 525 through an interconnect 523 (e.g., a USB4 link) via corresponding interfaces/ports 522 and 526.

Switch/bridge 520 routes packets/messages from device 525 upstream, i.e., up a hierarchy towards a root complex, to controller hub 515 and downstream, i.e., down a hierarchy away from a root controller, from processor 505 or system memory 510 to device 525. Device 525 may be any peripheral including any internal or external device or component to be coupled to an electronic system e.g., via a USB4 or other serial interface that provides for communication of one or more tunneled protocols in accordance with an embodiment. Device 525 may be an I/O device, a NIC, an add-in card, an audio processor, a network processor, a memory expander, a hard-drive, a storage device such as a solid state drive, a CD/DVD ROM, a monitor, a printer, a mouse, a keyboard, a router, a portable storage device, a Firewire device, a USB device, a scanner, and other input/output devices.

Graphics accelerator 530 is also coupled to controller hub 515 through serial link 532. In one embodiment, graphics accelerator 530 is coupled to an MCH, which is coupled to an ICH. Switch 520, and accordingly I/O device 525, is then coupled to the ICH. I/O modules 531 and 518 are also to implement a layered protocol stack to communicate between graphics accelerator 530 and controller hub 515. A graphics controller or the graphics accelerator 530 itself may be integrated in processor 505.

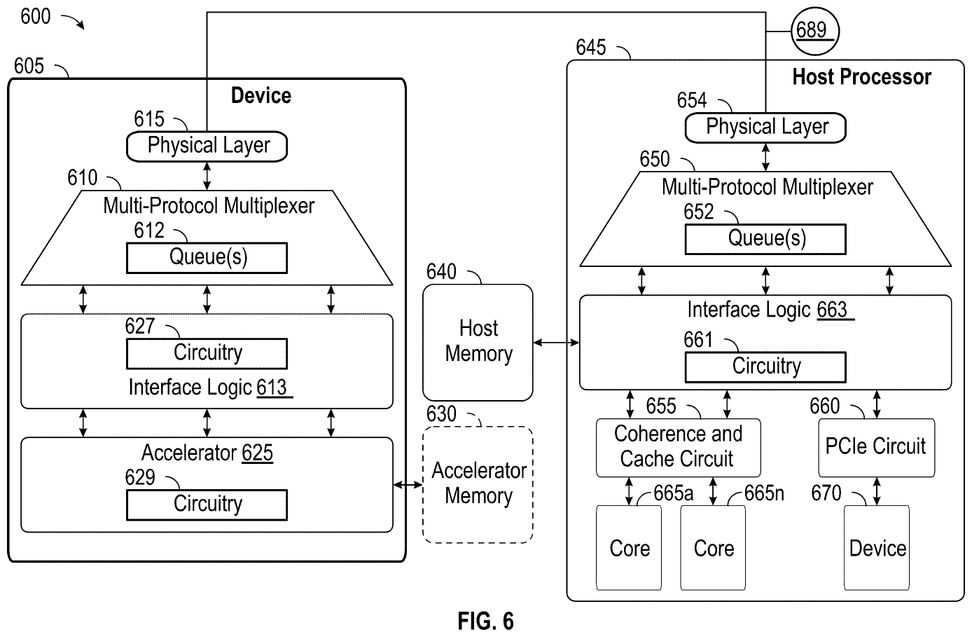

FIG. 6 is a block diagram of a system in accordance with an embodiment. As shown in FIG. 6 a device 605 may be an accelerator or processor device coupled to a host processor 645 via an interconnect 689, which may be an interconnect, bus, trace, and so forth. Device 605 and host processor 645 may communicate over link 689 to enable data and messages to pass therebetween. In some embodiments, link 689 may be operable to support multiple protocols and communication of data and messages via the multiple interconnect protocols, including a Compute Express Link (CXL) protocol in accordance with one or more CXL specifications. For example, link 689 may support various interconnect protocols, including a non-coherent interconnect protocol, a coherent interconnect protocol, and a memory interconnect protocol. Non-limiting examples of supported interconnect protocols may include PCI, PCIe, USB, IDI, IOSF, SMI, SMI3, SATA, CXL.io, CXL.cache, and CXL.mem, and/or the like.

In embodiments, device 605 may include an accelerator 625 including circuitry 629. In some instances, accelerator 625 and circuitry 629 may provide processing and memory capabilities. Examples of device 605 may include producer-consumer devices such as a graphics or other specialized accelerator, producer-consumer plus devices, software-assisted device memory devices, autonomous device memory devices, and giant cache devices. In some cases, accelerator 625 may couple to an optional accelerator memory 630. Accelerator 625 and circuitry 629 may provide the processing and memory capabilities based on the device. For example, accelerator 625 and circuitry 629 may communicate using, for example, a coherent interconnect protocol for various functions, such as coherent requests and memory flows with host processor 645 via interface logic 613 and circuitry 627.

In some embodiments, protocol queue 612 may be protocol specific such that each interconnect protocol may be associated with a particular protocol queue. Multiplexer 610 may also implement arbitration circuitry to arbitrate between communications of different protocols and provide selected communications to a physical layer 615.

In various embodiments, host processor 645 may be a main processor such as a CPU. Host processor 645, via an interface logic 663 including circuitry 661, may be coupled to a host memory 640. In one or more embodiments, circuitry 661 may include filter circuitry and storage for an existing device map as described herein, to enable filtering of configuration read requests to absent BDFs. Host processor 645 also may include a coherence and cache circuit 655, which may include a cache hierarchy. Circuit 655 may communicate with one or more cores 665a-n. In some embodiments, circuit 655 may enable communication via one or more of a coherent interconnect protocol (e.g., CXL.cache) and a memory interconnect protocol (e.g., CXL.mem).

In various embodiments, host processor 640 may include a device 670 to communicate with a PCIe circuit 660 over an interconnect. In some embodiments, device 670 may be an I/O device, such as a PCIe I/O device. In other cases, one or more external devices such as PCIe devices may couple to PCIe 670.

In embodiments, host processor 645 may enable multi-protocol communication between the components of host processor 645 and device 605. To this end, as shown in FIG. 6, circuits 655 and 660 (collectively) may communicate any or all of CXL.io/PCIe, CXL.cache, and/or CXL.memory traffic with a multi-protocol multiplexer 650 having one or more protocol queues 652 to send and receive messages and data with device 605.

Protocol queue 652 may be protocol specific such that each interconnect protocol may be associated with a particular protocol queue. Multiplexer 650 may also implement arbitration circuitry to arbitrate between communications of different protocols and provide selected communications to a physical layer 654.

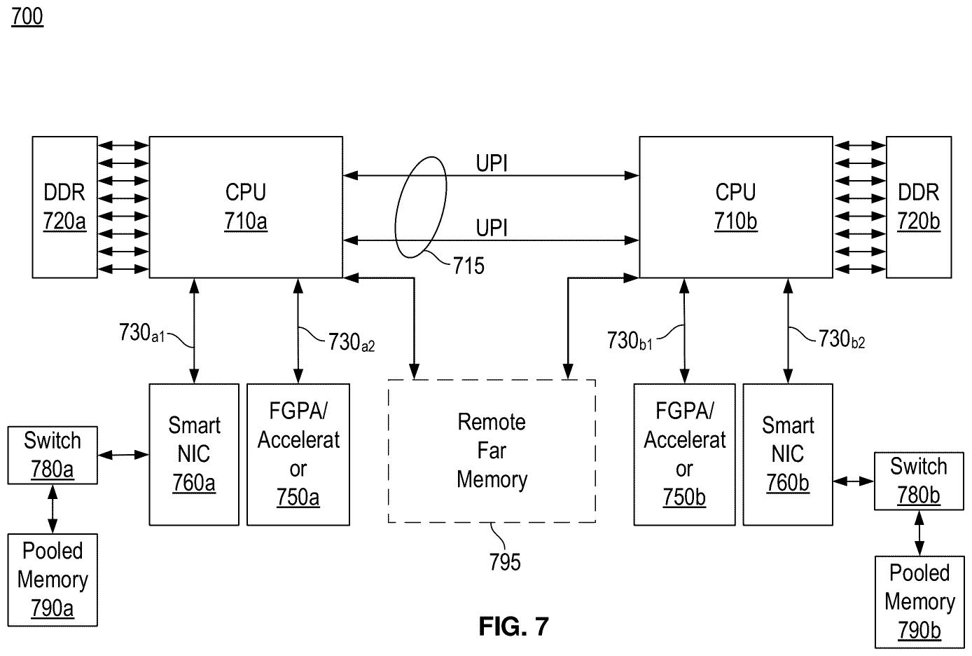

Referring now to FIG. 7, shown is a block diagram of a system in accordance with another embodiment. As shown in FIG. 7, a system 700 may be any type of computing device, and in one embodiment may be a server system such as an edge platform. In the embodiment of FIG. 7, system 700 includes multiple CPUs 710a, b that in turn couple to respective system memories 720a, b which in embodiments may be implemented as double data rate (DDR) memory. CPUs 710 may implement root complex circuitry including a filter and storage for an existing device map as described herein. Note that CPUs 710 may couple together via an interconnect system 715 such as an Intel® Ultra Path Interconnect or other processor interconnect technology.

To enable coherent accelerator devices and/or smart adapter devices to couple to CPUs 710 by way of potentially multiple communication protocols, a plurality of interconnects 730a1-b2 may be present. In an embodiment, each interconnect 730 may be a given instance of a CXL link.

In the embodiment shown, respective CPUs 710 couple to corresponding field programmable gate arrays (FPGAs)/accelerator devices 750a, b, in one embodiment. In addition CPUs 710 also couple to smart network interface circuit (NIC) devices 760a, b. In turn, smart NIC devices 760a, b couple to switches 780a, b that in turn couple to a pooled memory 790a, b such as a persistent memory. As shown information can be stored in a pooled memory 790. In turn, CPUs 710 or other entities may access and further process this information from pooled memory 790. In addition, CPUs 710 may couple to an optional remote far memory 795.

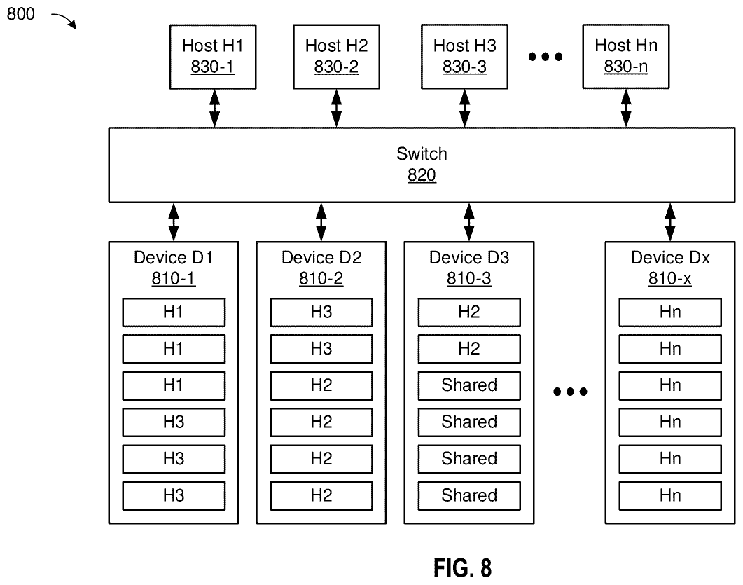

Referring now to FIG. 8, shown is a block diagram of another example system in accordance with an embodiment. In FIG. 8, system 800 may be all or part of a rack-based server having multiple hosts in the form of compute drawers that may couple to pooled memory via one or more switches.

As shown, multiple hosts 830-1-n (also referred to herein as “hosts 830”) are present. Each host may be implemented as a compute drawer having one or more SoCs (which may be implemented as multi-die packages including root complexes having filter circuitry and storage for an existing device map as described herein), memory, storage, interface circuitry and so forth. In one or more embodiments, each host 830 may include one or more virtual hierarchies corresponding to different cache coherence domains. Hosts 830 may couple to a switch 820, which may be implemented as a CXL switch (e.g., a CXL 2.0 (or later) switch). In an embodiment, each host 830 may couple to switch 820 using an off-package interconnect, e.g., a Universal Chiplet Interconnect Express (UCIe) interconnect running a CXL protocol.

Switch 820 may couple to multiple devices 810-1-x (also referred to herein as “device 810”), each of which may be a memory device (e.g., a Type 3 CXL memory expansion device) and/or an accelerator. In the illustration of FIG. 8, each device 810 is shown as Type 3 memory device having any number of memory regions (e.g., defined partitions, memory ranges, etc.). Depending on configuration and use case, certain devices 810 may include memory regions assigned to particular hosts while others may include at least some memory regions designated as shared memory. Although embodiments are not limited in this regard, the memory included in devices 810 may be implemented with any type(s) of computer memory (e.g., dynamic random-access memory (DRAM), static random-access memory (SRAM), non-volatile memory (NVM), a combination of DRAM and NVM, etc.).

The following examples pertain to further embodiments.

In one example, an apparatus comprises: a filter to receive a first configuration read access request and direct the first configuration read access request to a first root port, and receive a second configuration read access request and prevent the second configuration read access request from being sent to a second root port, wherein a destination of the first configuration read access request is an implemented device of a system and a destination of the second configuration read access request is an unimplemented device; and a storage coupled to the filter, the storage to store an identification of implemented devices and unimplemented devices.

In an example, the filter is to access the storage to identify whether a first device comprising the destination of the first configuration read access request is implemented in the system.

In an example, the storage comprises a plurality of registers, each register to store a plurality of presence values, each of the plurality of presence values to indicate whether a particular BDF identifier is implemented in the system.

In an example, the storage is to store a map to identify the implemented devices and the unimplemented devices.

In an example, the map is encoded according to 32x8y+z, where x equals a bus identifier, y equals a device identifier and z equals a function identifier.

In an example, the apparatus comprises a root complex comprising the filter and the storage, the storage comprising at least one root complex configuration register.

In an example, in response to the second configuration read access request to the unimplemented device, the filter is to send a predetermined value to a requester of the second configuration read access request.

In an example, the predetermined value comprises 0xFFFF.

In an example, the apparatus comprises an error mask register, wherein an unsupported request error indicator of the error mask register is to remain enabled during a boot and during normal operation.

In an example, during a boot, an agent is to perform a bus scan to: identify presence of the implemented devices and absence of the unimplemented devices; and in response to the identification, write an existing device map to the storage.

In an example, when the apparatus is implemented in a hot plug system, the agent is to write the existing device map to indicate that all implemented and unimplemented devices are present.

In an example, during the bus scan, the agent is to receive a vendor ID from the implemented devices, receive unsupported request indicators for the unimplemented devices, and write the existing device map based thereon.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a method comprises: receiving, in a root complex of a system, a configuration read for a first BDF; accessing a storage to identify whether the first BDF is present in the system; in response to identifying that the first BDF is present in the system, sending the configuration read to the first BDF; and in response to identifying that the first BDF is absent from the system, sending a predetermined value to a source of the configuration read.

In an example, the method further comprises accessing the storage comprising a map stored in a register storage of the root complex.

In an example, the method further comprises writing the map into the register storage based at least in part on a scan of a fabric coupled to the root complex during a pre-boot environment.

In an example, the method further comprises enabling unsupported error reporting during a boot of the system and maintaining the unsupported error reporting during operation of the system.

In an example, the method further comprises in response to identifying that the second BDF is absent from the system, preventing the configuration read to the second BDF from being sent to a root port associated with the second BDF.

In another example, a system comprises: a root complex comprising: at least one CPU; a plurality of root ports to couple to one or more devices; an address decoder coupled to the at least one CPU and to decode an address of a configuration read request; a filter coupled to the address decoder, the filter to receive the configuration read request and the decoded address and prevent the configuration read request from being directed to a root port associated with the decoded address when a device is not present at the decoded address; and a memory coupled to the root complex.

In an example, the root complex further comprises a storage to store an existing device map having a plurality of presence values, each of the plurality of presence values to indicate whether a particular bus device function (BDF) is present in the system.

In an example, the filter is to further send a predetermined value to the at least one CPU in response to the configuration read request when the device is not present at the decoded address.

In a still further example, an apparatus comprises: means for receiving a configuration read for a first BDF means; means for accessing a storage means for identifying whether the first BDF means is present in a system; means for sending the configuration read to the first BDF means, in response to identifying that the first BDF means is present in the system; and means for sending a predetermined value to a source of the configuration read, in response to identifying that the first BDF means is absent from the system.

In an example, the apparatus further comprises the storage means comprising a map stored in a register storage means of a root complex means.

In an example, the apparatus further comprises means for writing the map into the register storage means based at least in part on a scan of a fabric means coupled to the root complex means during a pre-boot environment.

In an example, the apparatus further comprises means for enabling unsupported error reporting during a boot of the system and means for maintaining the unsupported error reporting during operation of the system.

In an example, the apparatus further comprises means for preventing the configuration read to the second BDF means from being sent to root port means associated with the second BDF means, in response to identifying that the second BDF means is absent from the system.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured in to a SOC or other processor, is to configure the SOC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present disclosure has been described with respect to a limited number of implementations, those skilled in the art, having the benefit of this disclosure, will appreciate numerous modifications and variations therefrom. It is intended that the appended claims cover all such modifications and variations.

1-25. (canceled)

26. An apparatus comprising:
a filter to receive a first configuration read access request and direct the first configuration read access request to a first root port, and receive a second configuration read access request and prevent the second configuration read access request from being sent to a second root port, wherein a destination of the first configuration read access request is an implemented device of a system and a destination of the second configuration read access request is an unimplemented device; and
a storage coupled to the filter, the storage to store an identification of implemented devices and unimplemented devices.

27. The apparatus of claim 26, wherein the filter is to access the storage to identify whether a first device comprising the destination of the first configuration read access request is implemented in the system.

28. The apparatus of claim 26, wherein the storage comprises a plurality of registers, each register to store a plurality of presence values, each of the plurality of presence values to indicate whether a particular bus device function (BDF) identifier is implemented in the system.

29. The apparatus of claim 27, wherein the storage is to store a map to identify the implemented devices and the unimplemented devices.

30. The apparatus of claim 29, wherein the map is encoded according to 32x8y+z, wherein x equals a bus identifier, y equals a device identifier and z equals a function identifier.

31. The apparatus of claim 26, wherein the apparatus comprises a root complex comprising the filter and the storage, the storage comprising at least one root complex configuration register.

32. The apparatus of claim 26, wherein in response to the second configuration read access request to the unimplemented device, the filter is to send a predetermined value to a requester of the second configuration read access request.

33. The apparatus of claim 32, wherein the predetermined value comprises 0xFFFF.

34. The apparatus of claim 26, wherein the apparatus comprises an error mask register, wherein an unsupported request error indicator of the error mask register is to remain enabled during a boot and during normal operation.

35. The apparatus of claim 26, wherein during a boot, an agent is to perform a bus scan to:
identify presence of the implemented devices and absence of the unimplemented devices; and
in response to the identification, write an existing device map to the storage.

36. The apparatus of claim 35, wherein when the apparatus is implemented in a hot plug system, the agent is to write the existing device map to indicate that all implemented and unimplemented devices are present.

37. The apparatus of claim 35, wherein during the bus scan, the agent is to receive a vendor ID from the implemented devices, receive unsupported request indicators for the unimplemented devices, and write the existing device map based thereon.

38. A method comprising:
receiving, in a root complex of a system, a configuration read for a first bus device function (BDF);
accessing a storage to identify whether the first BDF is present in the system;
in response to identifying that the first BDF is present in the system, sending the configuration read to the first BDF; and
in response to identifying that the first BDF is absent from the system, sending a predetermined value to a source of the configuration read.

39. The method of claim 38, further comprising accessing the storage comprising a map stored in a register storage of the root complex.

40. The method of claim 39, further comprising writing the map into the register storage based at least in part on a scan of a fabric coupled to the root complex during a pre-boot environment.

41. The method of claim 38, further comprising enabling unsupported error reporting during a boot of the system and maintaining the unsupported error reporting during operation of the system.

42. The method of claim 38, further comprising in response to identifying that a second BDF is absent from the system, preventing a configuration read to the second BDF from being sent to a root port associated with the second BDF.

43. A system comprising:
a root complex comprising:
at least one central processing unit (CPU);
a plurality of root ports to couple to one or more devices;
an address decoder coupled to the at least one CPU and to decode an address of a configuration read request;
a filter coupled to the address decoder, the filter to receive the configuration read request and the decoded address and prevent the configuration read request from being directed to a root port associated with the decoded address when a device is not present at the decoded address; and
a memory coupled to the root complex.

44. The system of claim 43, wherein the root complex further comprises a storage to store an existing device map having a plurality of presence values, each of the plurality of presence values to indicate whether a particular bus device function (BDF) is present in the system.

45. The system of claim 43, wherein the filter is to further send a predetermined value to the at least one CPU in response to the configuration read request when the device is not present at the decoded address.
